(19) United States
(12) Patent Application Publication
(10) Pub. No.: US 2025/0106323 A1
(43) Pub. Date: Mar. 27, 2025

(54) EVENT-BASED APPLICATION INTERFACE TRANSMISSION ACROSS MOBILE DEVICES

(71) Applicant: Motorola Mobility LLC, Chicago, IL (US)

(72) Inventors: Amit Kumar Agrawal, Bangalore (IN); Shuaib Puzhakkal Kavalathara, Malappuram (IN); Ritwik Nandi Mazumder, Guwahati (IN)

(73) Assignee: Motorola Mobility LLC, Chicago, IL (US)

(21) Appl. No.: 18/372,265

(22) Filed: Sep. 25, 2023

(51) Int. Cl. H04M 3/58; H04M 1/72451; H04M 3/42

(52) U.S. Cl. CPC H04M 3/58; H04M 1/72451; H04M 3/42042

(57) ABSTRACT

In aspects of event-based application interface transmission across mobile devices, a mobile device detects an event associated with a first application on the first mobile device; transmits an interface of a second application installed on the first mobile device to a second mobile device based on the event associated with the first application and a request to use the second application on the first mobile device; and receives, from the second mobile device, monitoring information associated with use of the second application on the second mobile device.

### BACKGROUND

Typical households include multiple mobile devices. Each of the mobile devices may include several mobile applications. In some cases, certain applications (e.g., financial applications, payment applications, shopping applications, subscription applications, etc.) are kept on one of the mobile devices in a household. The primary user of this mobile device has access to these certain applications on his or her mobile device while the other mobile devices in the household do not have access to these certain applications on their mobile devices. When a member of the household other than the primary user wants to use one of these certain applications, the member must use the primary user's mobile device. Thus, this situation presents multiple problems. For example, when the primary user is using his or her phone, the other members of the household cannot access the certain applications on the primary user's mobile device. Also, when a member of the household is using the primary user's mobile device to use one of the certain applications, the primary user is blocked from using his or her mobile device.

### BRIEF DESCRIPTION OF THE DRAWINGS

Implementations of the techniques for event-based application interface transmission across mobile devices are described with reference to the following Figures. The same numbers may be used throughout to reference like features and components shown in the Figures.

FIG. 1 illustrates an example system for event-based application interface transmission across mobile devices in accordance with one or more implementations as described herein.

FIG. 2 illustrates an example flow diagram for event-based application interface transmission across mobile devices in accordance with one or more implementations as described herein.

FIGS. 3A-3D illustrate example flow diagrams of event-based application interface transmission across mobile devices in accordance with one or more implementations as described herein.

FIGS. 4 and 5 illustrate example methods for event-based application interface transmission across mobile devices in accordance with one or more implementations of the techniques described herein.

FIG. 6 illustrates various components of an example device that may be used to implement the techniques for event-based application interface transmission across mobile devices as described herein.

### DETAILED DESCRIPTION

Generally, a household includes multiple mobile devices where each mobile devices includes multiple mobile applications. In some cases, a user of a mobile device may share his or her mobile device with another person to let the other person use an application on the user's mobile device. Based on conventional approaches, when the user shares his or her mobile device with the other person, the user is blocked from using his or her mobile device. For example, a user can lend his or her phone to another user to let the other user access an application on the user's mobile device. Also, when the user receives a phone call, the user can hand his or her mobile device to another person to continue the conversation. Based on conventional approaches, the user loses access to his or her phone as long as the conversation continues. Alternatively, based on conventional approaches, the other person can use his or her own mobile device to dial the person that called the user, which allows the user to continue to use his or her mobile device, but makes the caller wait as it requires the other user to take the time dial manually. Also, based on conventional approaches, when the user is already using his or her mobile device, the other person is blocked from using the user's mobile device. For example, when the user is on a video call or when a video call is scheduled to occur shortly (e.g., within the next 5 minute), then the other person is not able to access an application on the user's mobile device before or during the video call. The mobile device collaboration techniques described herein provide application transfer functionality to remedy such scenarios that arise as a result of conventional approaches.

In aspects of the described techniques, the application transfer functionality described herein enables a user to maintain control of a first mobile device while another user uses a second mobile device to access an application executing on the first mobile device. In one or more examples, the application transfer functionality is performed via at least one mobile device.

In implementations, an active event is detected on a first mobile device or detect a scheduled event on the first mobile device. Examples of the active event include an active use of a first application on the first mobile device (e.g., currently on a video call using a video call application of the first mobile device). Examples of the scheduled event include a scheduled use of the first application on the first mobile device (e.g., a scheduled video call using a video call application of the first mobile device).

In one or more examples, a request to use a second application on the first mobile device is detected. For example, the second application is identified based on the request and it is determined that use of the second application conflicts with an active event (e.g., with an ongoing video call) or with a scheduled event (e.g., with an upcoming video call). For instance, an incoming voice call (e.g., a request to use a second application) is detected on the first mobile device while the user is on a video call (e.g., the first application). The incoming voice call uses a first radio of the first mobile device (e.g., a first cellular radio, a first wireless radio) while the video call uses a second radio of the first mobile device. For example, when the incoming voice call uses the first cellular radio the video call uses the first wireless radio or a second cellular radio. When the incoming voice call uses the first wireless radio the video call uses the first cellular radio or a second wireless radio. In some cases, the incoming voice call and the video call are handled over one or more WIFI® connections of the first mobile device.

In implementations, the second application is transferred from the first mobile device to a second mobile device. In one or more variations, control of the second application is shared with or transferred to the second mobile device. Additionally or alternatively, the second application is shared with and/or a sharing interface of the second application is enabled on the second mobile device. For example, the first mobile device transfers the incoming call from the first mobile device to the second mobile device while maintaining the video call on the first mobile device. The first mobile device continues handling the video call and the incoming call, relaying the incoming call to the second mobile device.

In implementations, monitors the sharing of the second application to the second mobile device is monitored. Based on the monitoring, the sharing of the second application can be terminated. For example, that the second application being closed on the second mobile device is detected (e.g., a user on the second mobile device closes the sharing interface of the second application) and/or user input is received on the first mobile device instructing to stop sharing the second application.

The techniques described herein provide multiple advantages. For example, the techniques enable event-based application interface transmission across mobile devices (e.g., device to device application sharing, application transfer). The application transfer functionality enables a user to continue to use a first application on his or her mobile device or maintain access to his or her mobile device (e.g., for a scheduled use of the first application, a scheduled video call) while enabling another user to interface with a second application installed on the user's mobile device. Thus, the application transfer functionality described herein allows a first user to use his or her mobile device however he or she wishes to use the mobile device while concurrently enabling a second user to use a second mobile device to access a second application and/or an account associated with the first user's mobile device (e.g., where the second application and/or account is not installed on the second mobile device).

The application transfer functionality provides an interface on the first mobile device that enables the first user to transfer a second application to a second mobile device, allowing a user to use the first mobile device how he or she wishes. Additionally or alternatively, the application transfer functionality provides an interface on the second mobile device that enables the second user to use and/or control one or more aspects of the second application on the second mobile device. Thus, the application transfer functionality enables a first user to access, via a first mobile device, a first application executing on the first mobile device and enables a second user to access, via a second mobile device, a second application executing concurrently on the first mobile device. Similarly, the application transfer functionality enables a first user to maintain availability of the first mobile device (e.g., for an upcoming video call, etc.) while concurrently enabling the second user to access, via the second mobile device, the second application executing on the first mobile device.

While features and concepts of the described techniques for event-based application interface transmission across mobile devices are implemented in any number of different mobile devices, systems, environments, and/or configurations, implementations of the techniques for event-based application interface transmission across mobile devices are described in the context of the following example devices, systems, and methods.

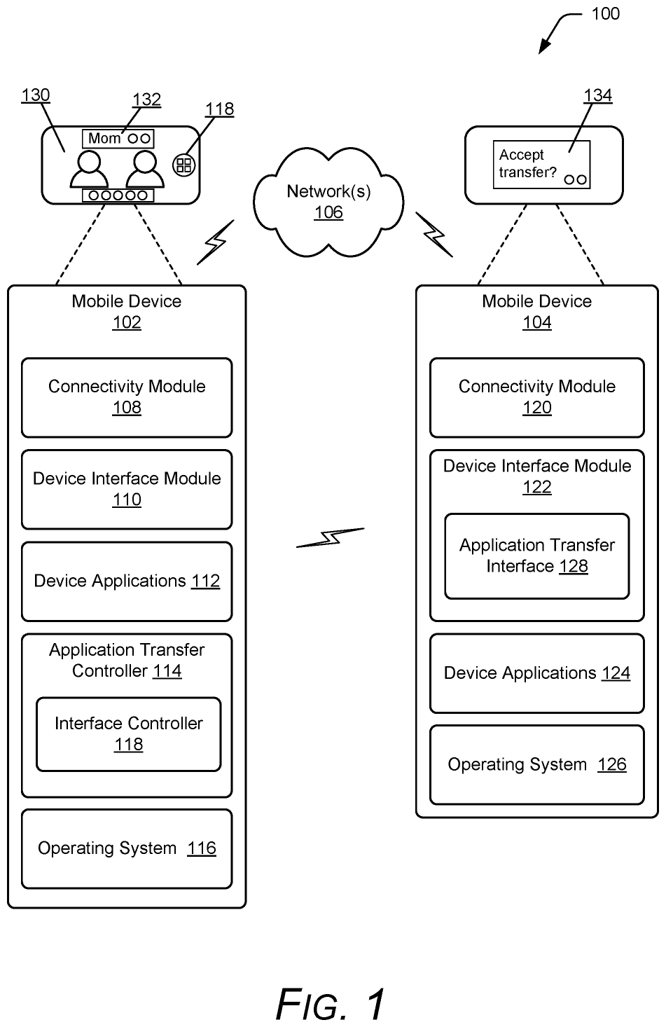

FIG. 1 illustrates an example system 100 for event-based application interface transmission across mobile devices, as described herein. The system 100 includes one or more mobile devices, such as a mobile device 102 and/or a mobile device 104. Examples of mobile devices include at least one of any type of a wireless device, mobile device, mobile phone, flip phone, client device, wearable computing device, camera device, display device, tablet computing device, communication device, entertainment device, gaming device, media playback device, any other type of computing and/or electronic device, and/or a system of any combination of such devices.

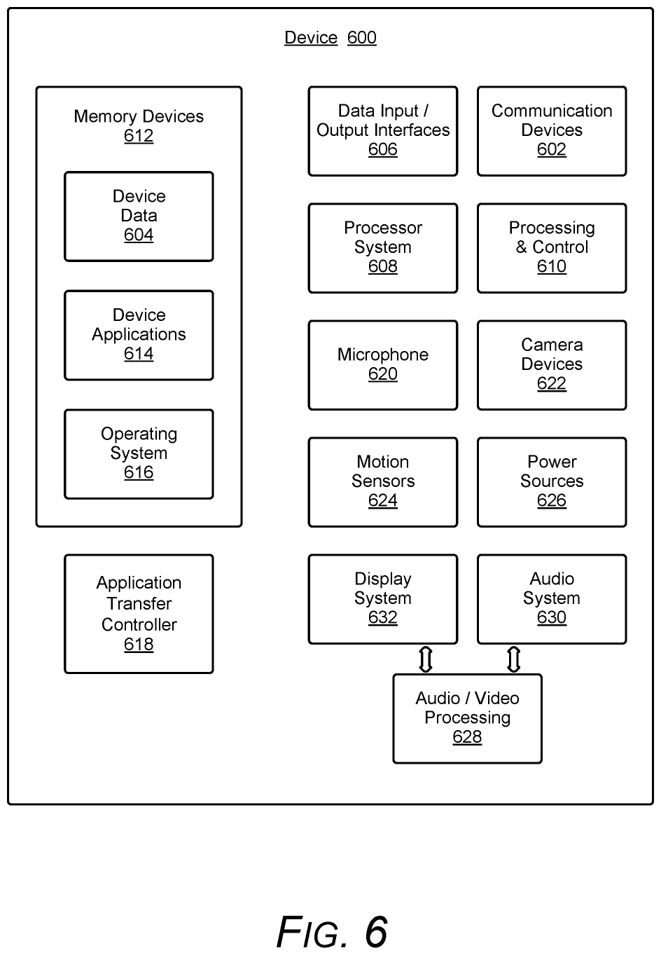

The mobile device 102 and/or the mobile device 104 is implemented with various components, such as a processor system and memory, as well as any number and combination of different components as further described with reference to the example device shown in FIG. 6. In implementations, the mobile device 102 includes various radios for wireless communication with other devices. In one or more examples, the mobile device 102 includes at least one of a BLUETOOTH® (BT) or BLUETOOTH® Low Energy (BLE) transceiver, a near field communication (NFC) transceiver, or the like. In some cases, the mobile device 102 includes at least one of a WI-FI® radio, a cellular radio, a global positioning satellite (GPS) radio, or any available type of device communication interface.

The mobile device 104 is implemented with various components, such as a processor system and memory, as well as any number and combination of the different components as further described with reference to the example device shown in FIG. 6. In implementations, the mobile device 102 is communicatively linked, either by a wired or wireless connection, to the mobile device 104. For example, the mobile device 102 and the mobile device 104 are communicatively linked via a communication network 106 and/or via direct inter-device connectivity, e.g., via direct wireless and/or wired connectivity between the mobile device 102 and the mobile device 104.

In some implementations, the devices, applications, modules, servers, and/or services described herein communicate via the communication network 106, such as for data communication between the mobile device 102 and the mobile device 104. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionalities that enable the device to implement different aspects of event-based application interface transmission across mobile devices, as described herein. In the illustrated example, the mobile device 102 includes a connectivity module 108, a device interface module 110, device applications 112 (e.g., one or more device applications), and an application transfer controller 114. The connectivity module 108 represents functionality (e.g., logic, software, and/or hardware) enabling the mobile device 102 to interconnect with other devices and/or networks, such as the mobile device 104 and the communication network 106. For example, the connectivity module 108 enables wireless and/or wired connectivity of the mobile device 102. The device interface module 110 represents functionality enabling the mobile device 102 to interface with other devices. As further detailed below, the device interface module 110 enables the mobile device 102 to establish wireless and/or wired data communication with other devices, such as the mobile device 104 or similar presentation device.

Each of the connectivity module 108, the device interface module 110, the device applications 112, the application transfer controller 114, and the operating system 116 can be implemented in a variety of different manners. For example, each of the connectivity module 108, the device interface module 110, the device applications 112, the application transfer controller 114, and the operating system 116 can be implemented as multiple instructions stored on computer-readable storage media and that can be executed by a processor system of the mobile device 102. Additionally or alternatively, each of the connectivity module 108, the device interface module 110, the device applications 112, the application transfer controller 114, and the operating system 116 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the connectivity module 108, the device interface module 110, the device applications 112, the application transfer controller 114, and the operating system 116 can be implemented in the same manner, or the connectivity module 108, the device interface module 110, the device applications 112, the application transfer controller 114, and the operating system 116 can each be implemented in a different manner.

The mobile device 104 includes various functionality that enable the mobile device 104 to implement different aspects of event-based application interface transmission across mobile devices, as described herein. In the illustrated example, the mobile device 104 includes a connectivity module 120, a device interface module 122, device applications 124 (e.g., one or more device applications), and an operating system 126. The device interface module 122 includes an application transfer interface 128. The connectivity module 120 represents functionality (e.g., logic, software, and/or hardware) enabling the mobile device 104 to interconnect with other devices and/or networks, such as the mobile device 102 and the communication network 106. For example, the connectivity module 120 enables wireless and/or wired connectivity of the mobile device 104. The device interface module 122 represents functionality enabling the mobile device 104 to interface with other devices. As further detailed below, the device interface module 122 enables the mobile device 104 to establish wireless and/or wired data communication with other devices, such as the mobile device 102 or similar devices. The application transfer interface 128 provides an interface to the application transfer controller 114 of the mobile device 102. In one or more examples, the mobile device 104 includes an instance of the application transfer controller 114 that provides the application transfer interface 128, enabling the mobile device 104 to interact with the application transfer controller 114 of the mobile device 102.

The device applications 112 represent functionality for performing different computing tasks via the mobile device 102, such as gaming, media consumption (e.g., content streaming), productivity tasks (e.g., word processing, content generation, data analysis, etc.), content generation, web browsing, communication with other devices, and so forth. Similarly, the device applications 124 represent functionality for performing different computing tasks via the mobile device 104, such as gaming, media consumption (e.g., content streaming), productivity tasks (e.g., word processing, content generation, data analysis, etc.), content generation, web browsing, communication with other devices, and so forth.

The operating system 116 manages hardware, software, and firmware resources in the mobile device 102. The operating system 116 manages the device applications 112 running on the mobile device 102 and operates as an interface between device applications 112 and hardware components of the mobile device 102. Similarly, the operating system 126 manages hardware, software, and firmware resources in the mobile device 104. The operating system 126 manages the device applications 124 running on the mobile device 104 and operates as an interface between device applications 124 and hardware components of the mobile device 104.

The mobile device 102 and/or the mobile device 104 can include and implement device applications 112 and/or device applications 124, such as any type of messaging application, email application, video communication application, cellular communication application, music/audio application, gaming application, median application, social platform application, and/or any other of the many possible types of device applications. Many of the device applications 112 have an associated application user interface that is generated and displayed for user interaction and viewing, such as on a display screen of the mobile device 102 and/or on a display of the mobile device 104. Generally, an application user interface, or any other type of video, image, graphic, and the like is digital image content that is displayable on the display screen of the mobile device 102 and/or on the display of the mobile device 104.

Each of the connectivity module 120, the device interface module 122, the device applications 124, the operating system 126, and the application transfer interface 128 can be implemented in a variety of different manners. For example, each of the connectivity module 120, the device interface module 122, the device applications 124, the operating system 126, and the application transfer interface 128 can be implemented as multiple instructions stored on computer-readable storage media and that can be executed by a processor system of the mobile device 102. Additionally or alternatively, each of the connectivity module 120, the device interface module 122, the device applications 124, the operating system 126, and the application transfer interface 128 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). One or more of the connectivity module 120, the device interface module 122, the device applications 124, the operating system 126, and the application transfer interface 128 can be implemented in the same manner, or can each be implemented in a different manner.

In one or more examples, a connectivity session is established between the mobile device 102 and the mobile device 104 that enables the mobile device 102 to send output content to and/or receive output content from the mobile device 104. In one or more implementations, the connectivity session is established via intercommunication between the device interface module 110 of the mobile device 102 and the device interface module 110 of the mobile device 104. The output content is any type of digital video, images, audio, application interfaces, etc. In one or more implementations, the mobile device 104 can output the output content at the device.

In the example system 100 for event-based application interface transmission across mobile devices, the mobile device 102 and the mobile device 104 are mobile devices that incorporate application transfer functionality. At least one of the mobile device 102 or the mobile device 104 implements an instantiation of an application transfer controller 114 (e.g., as a device application 112). The application transfer controller 114 represents functionality (e.g., logic, software, and/or hardware) enabling implementation of described techniques for event-based application interface transmission across mobile devices. The application transfer controller 114 can be implemented as computer instructions stored on computer-readable storage media and can be executed by a processor system of the mobile device 102 and/or of the mobile device 104. Alternatively or in addition, the application transfer controller 114 can be implemented at least partially in hardware of a device.

In one or more implementations, the application transfer controller 114 includes independent processing, memory, and/or logic components functioning as a computing and/or electronic device integrated with the mobile device 102 and/or with the mobile device 104. Alternatively or in addition, the application transfer controller 114 can be implemented in software, in hardware, or as a combination of software and hardware components. In one or more examples, the application transfer controller 114 is implemented as a software application or module, such as executable software instructions (e.g., computer-executable instructions) that are executable with a processor system of the mobile device 102 and/or the mobile device 104 to implement the techniques and features described herein. As a software application or module, the application transfer controller 114 is stored on computer-readable storage memory (e.g., memory of a device), or in any other suitable memory device or electronic data storage implemented with the module. Alternatively or in addition, the application transfer controller 114 is implemented in firmware and/or at least partially in computer hardware. For example, at least part of the application transfer controller 114 is executable by a computer processor, and/or at least part of the application transfer controller 114 is implemented in logic circuitry.

In one or more implementations, the mobile device 102 and the mobile device 104 belong to a group of devices (e.g., a family group of devices). In one or more variations, the mobile device 102 is a group leader device that is configured (e.g., via the application transfer controller 114) to control one or more aspects of the group such as adding a device to the group, removing a device from the group, configuring group settings, setting device permissions within the group, and the like. In one or more examples, transferring an application from the mobile device 102 to the mobile device 104 is based on the application transfer controller 114 determining that the mobile device 102 and the mobile device 104 being in the same group of devices.

In one or more examples, transferring an application from the mobile device 102 to the mobile device 104 is based on the mobile device 104 being a default device among one or more default devices preselected for transfer of one or more applications. Additionally or alternatively, transferring an application from the mobile device 102 to the mobile device 104 is based on the mobile device 104 being a preferred device among one or more preferred devices preselected for transfer of one or more applications. Additionally or alternatively, transferring an application from the mobile device 102 to the mobile device 104 is based on the mobile device 104 being a default device or preferred device for that application. For example, the application transfer controller 114 indicates that the mobile device 104 is a preferred device for a first application and that another mobile device in the group (and/or the mobile device 104) is a preferred device for a second application, and so on. Additionally or alternatively, the application transfer controller 114 scans for available devices and the transferring of an application to the mobile device 104 is based on the scan indicating that the mobile device 104 is available to receive an application transfer and/or that the mobile device 104 is within a given proximity of the mobile device 102 (e.g., within a proximity threshold such as 100 feet, 1000 feet, 1 mile, etc.). Additionally or alternatively, the application transfer controller 114 scans for available devices and the transferring of an application to the mobile device 104 is based on the scan indicating that the mobile device 104 is connected to a network (e.g., is accessible) and/or that the mobile device 104 is actively being used by a user.

When the application transfer controller 114 determines a preferred device or default device is not available (e.g., not within a given proximity, not accessible, not active), then the application transfer controller 114 selects another device from the group of devices. When no devices in the group are available, the application transfer controller 114 generates and displays a notification on the mobile device 102 that no devices are available. Additionally or alternatively, the application transfer controller 114 transmits a request (e.g., broadcasts the request) to one or more devices in the group to accept the request to transfer an application (e.g., to receive a transfer of the application) from the mobile device 102. When the application transfer controller 114 receives a response from one of the devices in the group approving the transfer, the application transfer controller 114 transfers the application to that device. When the application transfer controller 114 receives (e.g., based on the broadcast message) multiple responses from one of the devices in the group approving the transfer, the application transfer controller 114 selects one of the devices (e.g., a preferred device or default device) and transfers the application to that device.

In implementations, the application transfer controller 114 detects an event associated with a first application 130 on the mobile device 102. The event includes an active use of the first application 130 on the mobile device 102 such as an active telephone call, an active video call, an active mobile application, and the like. Additionally or alternatively, the event includes a scheduled use of the first application 130 on the mobile device 102 (e.g., a scheduled call, a scheduled video call, etc.) that conflicts with the use of a second application 132 on the mobile device 102.

In the illustrated example, the application transfer controller 114 detects that the mobile device 102 executes the first application 130. The application transfer controller 114 detects a request to use the second application 132 on the mobile device 102. The request to use the second application 132 includes at least one of an incoming phone call on the mobile device 102, a notification on a display of the mobile device 102, or a message received at the mobile device 102. In the illustrated example, the application transfer controller 114 detects an incoming call, where the second application 132 is a phone call application on the mobile device 102. As shown, the request includes a notification on the mobile device 102 indicating the incoming call with on-screen buttons to enable use of the phone call functions of the second application 132.

As shown, the application transfer controller 114 includes an interface controller 118 to enable the application transfer functionality described herein. In one or more examples, the interface controller 118 enables a user of the mobile device 102 to transfer an interface of the second application 132 to another mobile device. For example, the user of the mobile device 102 drags the second application 132 (e.g., drags a notification of the second application 132) to the interface controller 118 and the interface controller 118 transfers the interface of the second application 130 to the mobile device 104, enabling a user of the mobile device 104 to control one or more aspects of the second application 130. In the illustrated example, a notification of an incoming call appears on the screen of the mobile device 102 requesting that a calling application (e.g., the second application 132) be used to handle the incoming call. In response, the user slides the notification of the second application 132 to a graphic displayed on the mobile device 102 that represents at least one function of the interface controller 118. When the interface controller 118 detects that the notification of the second application 132 is dragged to the graphic, the interface controller 118 initiates the transfer of the second application 132 to the mobile device 104.

In implementations, the interface controller 118 transmits an interface of the second application 132 to the mobile device 104 based on the event associated with the first application 130 and the request to use the second application 132 on the mobile device 102. In implementations, the application transfer controller 114 transmits a message to the mobile device 104 requesting that the mobile device 104 receive the interface of the second application 130. As shown, the application transfer interface 128 displays a prompt 134 on a screen of the mobile device 104. The application transfer interface 128 generates the prompt 134 in response to the message from the application transfer controller 114 requesting that the mobile device 104 receive the interface of the second application 130. In one or more examples, the interface of the second application 132 is transmitted in response to an approval of the request received at the mobile device 102.

In the illustrated example, the application transfer interface 128 of the mobile device 104 receives the interface of the second application 132 from the interface controller 118. In one or more examples, the application transfer interface 128 provides an interface to the second application 132 executing on the mobile device 102. For example, when the second application 132 is an incoming phone call on the mobile device 102, the application transfer interface 128 provides a phone call interface to control one or more aspects of the phone call on the mobile device 104.

The interface of the second application 132 transmitted to the mobile device 104 differs from an interface of the second application 132 on the mobile device 102. For example, the transmission of the interface of the second application 132 includes the interface controller 118 transmitting instructions for providing the interface of the second application 132 on the mobile device 104 via the application transfer interface 128, while the second application executes on the mobile device 102. For example, the application transfer interface 128 receives the instructions for the interface of the second application 132 from the interface controller 118 and the application transfer interface 128 processes the instructions and provides the interface of the second application 132 on the mobile device 104 based on the processing of the instructions. The processing of the instructions includes at least an initial set of instructions for providing the interface of the second application 132, and/or a continuous stream of instructions for providing the interface of the second application 132 on the mobile device 104.

In implementations, the first application 130 utilizes a first wireless technology and the second application 132 utilizes a second wireless technology different from the first wireless technology. The mobile device 102 and the mobile device 104 each include at least one wireless radio (e.g., WI-FI® radio) and/or at least one cellular radio. In the illustrated example, the first application 130 is a video call application that utilizes at least one of a voice over internet protocol (VOIP) connection, a cellular connection, or a wireless connection. The second application 132 is an incoming call that utilizes at least one of the VOIP connection, the cellular connection, or the wireless connection. For example, when the first application 130 utilizes the wireless radio, the second application 132 utilizes the cellular radio. When the first application 130 utilizes the cellular radio, the second application 132 utilizes the wireless radio. In one or more examples, the mobile device 102 includes at least two wireless radios and/or at least two cellular radios (e.g., two subscriber identity module (SIM) cards). Thus, when the first application 130 utilizes a first wireless radio, the second application 132 utilizes the cellular radio or a second wireless radio. Additionally or alternatively, when the first application 130 utilizes a first cellular radio, the second application 132 utilizes a wireless radio or a second cellular radio.

In implementations, the interface controller 118 receives, from the application transfer interface 128, monitoring information associated with a use of the second application 132 on the mobile device 104. In one or more examples, the interface controller 118 terminates transmission of the interface of the second application 132 to the mobile device 104 based on the monitoring information transmitted by the application transfer interface 128. In one or more variations, the monitoring information received by the interface controller 118 indicates that the second application 132 is closed on the mobile device 104. In response, the interface controller 118 terminates access to the second application 132 on the mobile device 104. Additionally or alternatively, the interface controller 118 terminates transmission of the interface of the second application 132 to the mobile device 104 based on user input received at the mobile device 102. For example, the user of the mobile device 102 provides an input (e.g., presses an on-screen button, speaks a voice command, or otherwise interacts with of the second application 132 and/or of the interface controller 118) that modifies the transmission of the second application 132 to the mobile device 104. The modification of the transmission of the second application 132 includes at least one of a transfer of control of the second application 132 back to the mobile device 102 (e.g., transfers a call from the mobile device 104 back to the mobile device 102), removal of access to the second application 132 on the mobile device 104, termination of the sharing of the second application 132 to the mobile device 104, and/or termination of the second application 132 on the mobile device 102.

In implementations, the interface controller 118 provides media content (e.g., audio content and/or video content) to the mobile device 104 (e.g., to the device interface module 122). For example, the sharing of the second application 132 to the mobile device 104 can include the interface controller 118 sharing media content of the second application 132 with the mobile device 104. For instance, the interface controller 118 identifies the media content of the second application 132 (e.g., voice data of a phone call, video data of a video call, etc.) and streams the identified media content to the mobile device 104. Additionally or alternatively, the device interface module 122 identifies media content and/or user input associated with a user of the mobile device 104 interacting with the shared second application 132 on the mobile device 104 (e.g., voice data of a phone call, video data of a video call, etc.) and streams the media content and/or user input to the mobile device 102. For instance, the device interface module 122 can identify a user input at the mobile device 104 (e.g., a user of the mobile device 104 touching an on-screen button or clicking a physical button of the mobile device 104) and the device interface module 122 streams or relays the user input to the application transfer controller 114. Additionally or alternatively, the device interface module 122 identifies location information of the user input (e.g., a location on the screen of the mobile device 104 where the user touched the on-screen button) and streams or relays the location information to the application transfer controller 114.

In implementations, the second application 132 can include a phone call application as shown. Additionally or alternatively, the second application 132 includes a shopping application, a media streaming application, a payment application, or any other mobile application associated with a user account. In some cases, the second application 132 is installed and available on the mobile device 102, but is not installed and/or is not available to the mobile device 104. In one or more examples, a shopping application is installed on the mobile device 102 and is implemented based on being logged in with a user account. The user of the mobile device 102 knows or has the credentials to log in with the user account (e.g., user name, password, biometric login, etc.). The mobile device 104 can install the shopping application, but cannot implement or interact with the shopping application because the user of the mobile device 104 lacks the credentials to login to access the account. However, the application transfer controller 114 enables the user of the mobile device 104 to access the account information of the shopping application. For example, the application transfer controller 114 enables a user of the mobile device 102 to share the shopping application (e.g., the second application 132) with the mobile device 104, enabling the user of the mobile device 104 to access aspects of the shopping application based on the account information, including the user of the mobile device 104 interacting with the user interface of the shopping application, adding items to a shopping cart, and/or placing orders on the shopping application through the account. In implementations, the device interface module 122 provides a notification of a shopping cart to the mobile device 102, indicating the items in the shopping cart and requesting approval of the order being placed. Once the order is approved via the application transfer controller 114, the device interface module 122 provides a notification to the mobile device 102 that the order has been placed. Accordingly, the user of the mobile device 102 can terminate the sharing of the shopping application based on the notification that the order has been placed.

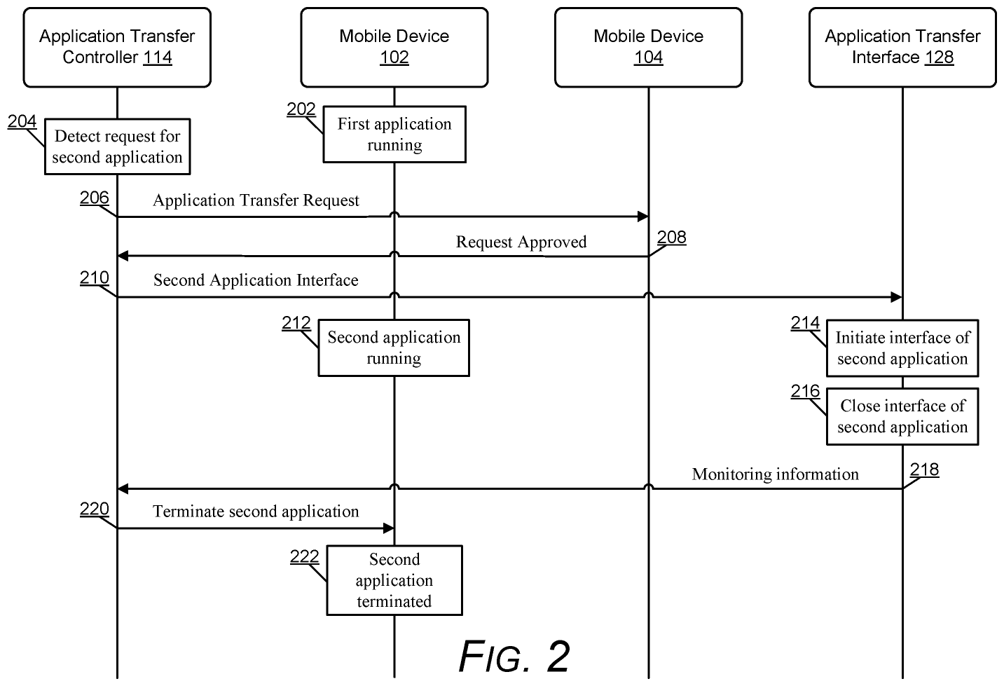

FIG. 2 illustrates an example flow diagram 200 for event-based application interface transmission across mobile devices. The order in which the flow diagram is described is not intended to be construed as a limitation, and any number or combination of the flow diagram operations described herein may be performed in any order to perform a method, or an alternate method.

At 202, a first application is running on the mobile device 102. For example, the application transfer controller 114 determines that the first application 130 is running on the mobile device 102.

At 204, the application transfer controller 114 detects a request to use a second application on the mobile device 102. In one or more examples, the request includes a notification that appears on a screen of the mobile device 102.

At 206, the application transfer controller 114 transmits an application transfer request to the mobile device 104. For example, the application transfer controller 114 generates and transmits the application transfer request to the mobile device 104. In implementations, a user of the mobile device 102 initiates an application transfer by providing user input at the mobile device 102. For example, the user provides a user input in response to a notification of the request to use the second application 132 appearing on a screen of the mobile device 102. In one or more variations, the application transfer interface 128 receives the application transfer request and displays a notification (e.g., the prompt 134) on a screen of the mobile device 104.

At 208, the mobile device 104 transmits an approval of the application transfer request to the mobile device 102. As shown, the approval of the application transfer request is received and/or processed by the application transfer controller 114. For example, the application transfer controller 114 receives the approval and initiates transfer of the second application 132 to the mobile device 104.

At 210, the application transfer controller 114 transfers an interface of the second application to the application transfer interface 128 of the mobile device 104. For example, the application transfer controller 114 transfers instructions to the application transfer interface 128 to provide an interface of the second application 132 on the mobile device 104 while the second application 132 executes on the mobile device 102. Accordingly, the interface of the second application 132 is based on the application transfer controller 114 handling instructions and/or data communications between the second application 132 and the application transfer interface 128.

At 212, the second application is running on the mobile device 102. For example, the application transfer controller 114 detects that the second application 132 is running on the mobile device 102 based on receiving the approval of the application transfer request.

At 214, the application transfer interface 128 initiates an interface of the second application. For example, the application transfer interface 128 receives instructions from the application transfer controller 114 to provide an interface of the second application 132 on the mobile device 104.

At 216, the application transfer interface 128 closes the interface of the second application. For example, the application transfer interface 128 detects an input of a user of the mobile device 104 requesting to close the interface of the second application 132 on the mobile device 104. Accordingly, the application transfer interface 128 closes the interface of the second application 132. For instance, the transferred application is an incoming call at the mobile device 102 where the second application 132 is a phone call application and a user of the mobile device 104 ends the transferred call. In response, the application transfer interface 128 closes the interface of the transferred call.

At 218, the application transfer interface 128 transmits monitoring information to the application transfer controller 114. For example, in response to the application transfer interface 128 detecting a request to end the interface of the second application 132, the application transfer interface 128 transmits monitoring information to the application transfer controller 114 that indicates that interface of the second application 132 is closed on the mobile device 104.

At 220, the application transfer controller 114 provides a termination request to the mobile device 102. For example, the application transfer controller 114 sends a termination request the operating system 116 of the mobile device 102 instructing the operating system 116 to end execution of the second application 132 on the mobile device 102 based on the monitoring information indicating that the interface of the second application 132 is closed on the mobile device 104.

At 222, the mobile device 102 terminates the second application. For example, in response to receiving the termination request from the application transfer controller 114, the operating system 116 of the mobile device 102 terminates that second application 132.

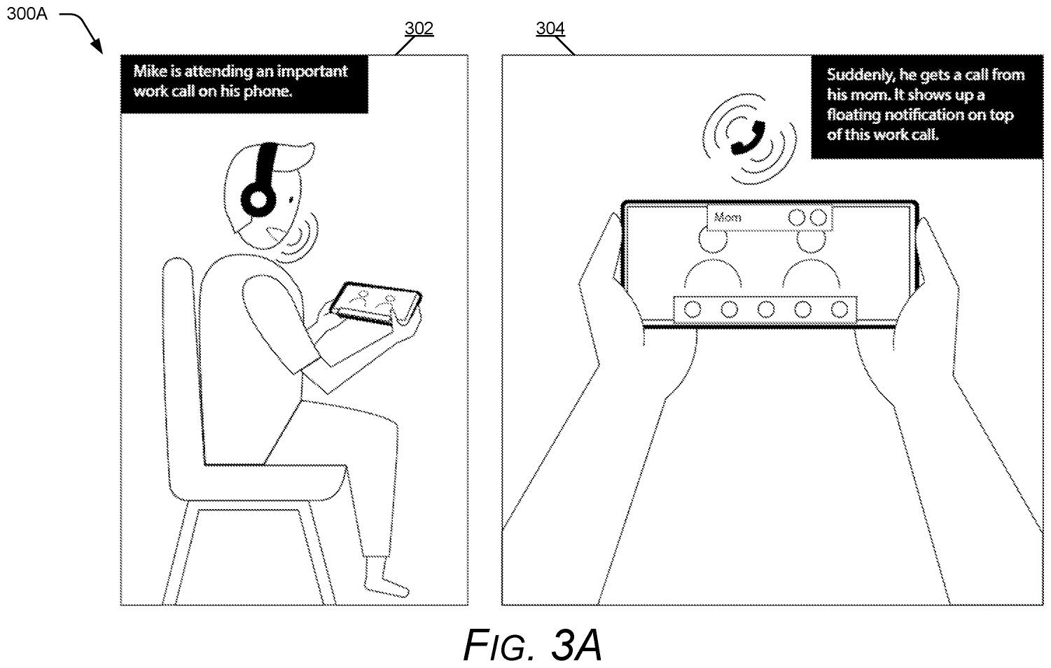

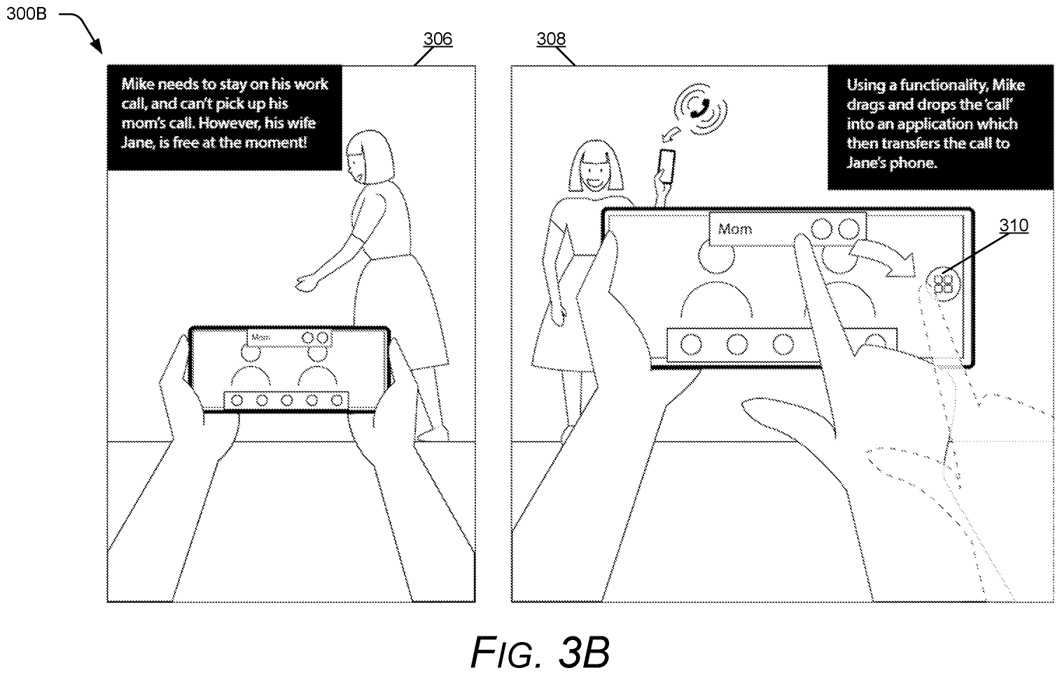

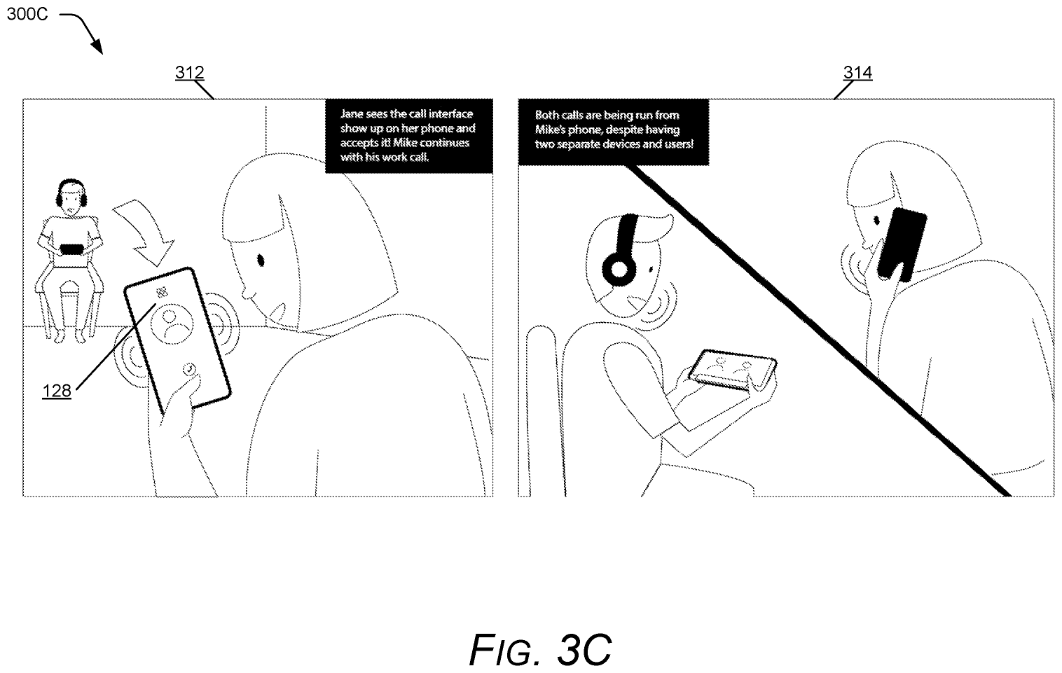

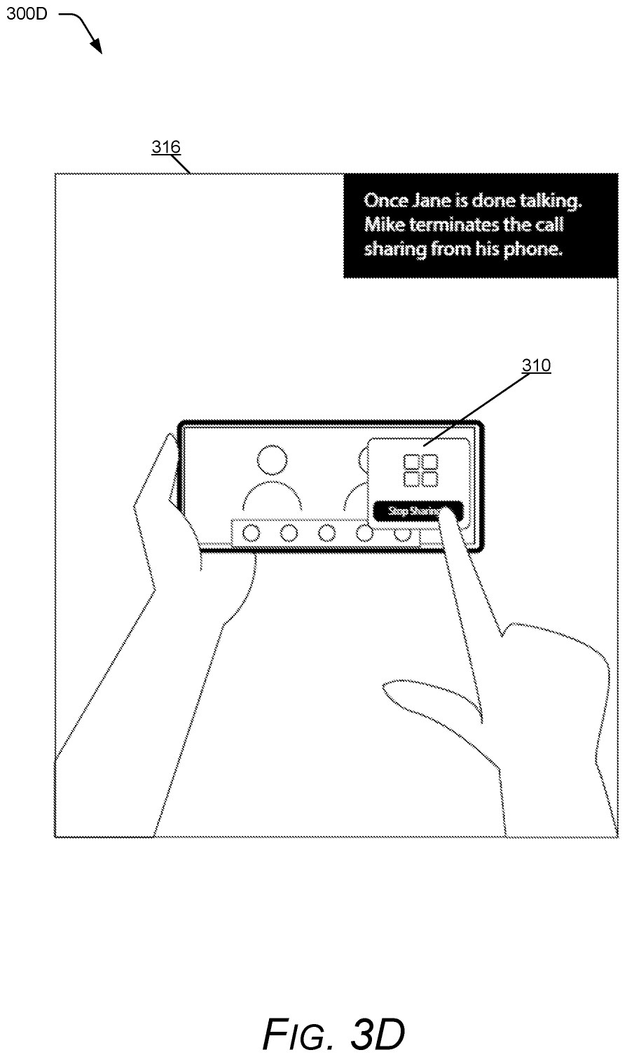

Example flow diagrams 300A, 300B, 300C, 300D, and methods 400 and 500 are described with reference to respective FIGS. 3A-3D, 4 and 5 in accordance with one or more implementations of event-based application interface transmission across mobile devices, as described herein. Generally, any services, components, modules, managers, controllers, methods, and/or operations described herein can be implemented using software, firmware, hardware (e.g., fixed logic circuitry), manual processing, or any combination thereof. Some operations of the example flow diagram and/or methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

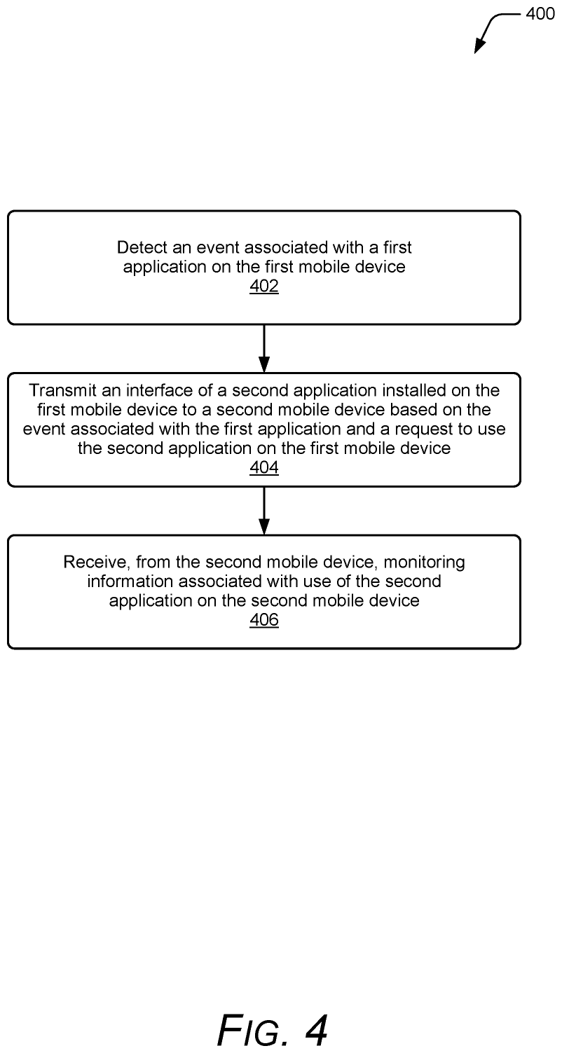

FIGS. 3A-3D illustrate an example flow diagram 300 of event-based application interface transmission across mobile devices, as described herein. As shown, the flow diagram 300 depicts a storyboard flow diagram demonstrating the application transfer functionality described herein. In some configurations, the flow diagram 300 may be implemented by the application transfer controller 114 illustrated in FIG. 1 or 2. In some configurations, the flow diagram 300A may be implemented in conjunction with mobile device 102, mobile device 104, components thereof, or any combination thereof. The order in which a given flow diagram is described is not intended to be construed as a limitation, and any number or combination of flow diagram and/or method operations described herein (e.g., of FIGS. 3A, 3B, 3C, 3D, 4, and/or 5) may be performed in any order to perform a flow diagram, a method, or an alternate method.

At 302, a user is attending an important work call on his mobile device. For example, the user is attending a video call with one or more other persons on the video call. In implementations, the application transfer controller 114 detects that the user is on the video call (e.g., a first application).

At 304, the user gets an incoming call from his mom. A notification of the incoming call appears on the screen of the user's mobile device in relation to the ongoing work call shown on the user's mobile device. However, the user needs to stay on the work call and cannot answer the incoming call. In implementations, the application transfer controller 114 detects that the incoming call (e.g., a request to use a second application) conflicts with the ongoing work call.

Referring to FIG. 3B, at 306, the user determines that his wife is available to take the incoming call. In implementations, the interface controller 118 provides an application transfer interface to enable the user to transfer the incoming call to another user's mobile device (e.g., to his wife's mobile device).

At 308, the user implements a function of the application transfer controller 114 to transfer the incoming call to his wife's mobile device. In the illustrated example, the application transfer controller 114 enables the user to drag the notification of the incoming call into an application transfer interface 310 provided by the interface controller 118.

Referring to FIG. 3C, at 312, the user's wife sees a notification of the incoming call on her mobile device. For example, the application transfer interface 128 provides a notification (e.g., the prompt 134) indicating the request to transfer the incoming call from the user's mobile device to the wife's mobile device. The wife uses the application transfer interface 128 to accept the transfer of the incoming call to her mobile device. Additionally or alternatively, the wife uses the application transfer interface 128 to handle and/or operate the transferred call on her mobile device.

At 314, the user continues his work call on his mobile device while the wife takes the incoming call. The user's mobile device handles both the work call and the incoming call. For example, a first radio transceiver on the user's mobile device handles the data communication of the work call while a second radio transceiver on the user's mobile device handles the data communication of the incoming call, including the data communicated between the user's mobile device and a base station, as well as the data communicated between the user's mobile device and the wife's mobile device. Thus, the user's mobile device continues handling the data communication of the work call while relaying the communication of the incoming to and from the wife's mobile device.

Referring to FIG. 3D, at 316, the user of the mobile device determines, while still on the work call, that his wife has finished the incoming call and the user terminates the sharing of the incoming call to his wife's mobile device using the application transfer interface 310 of the interface controller 118. Additionally or alternatively, the user of the mobile device can determine, after the work call, that his wife has finished the incoming call and the user then terminates the sharing of the incoming call to his wife's mobile device using the application transfer interface 310.

FIG. 4 illustrates example method(s) 400 for event-based application interface transmission across mobile devices. The order in which the method is described is not intended to be construed as a limitation, and any number or combination of the flow diagram and/or method operations described herein (e.g., of FIGS. 3A, 3B, 3C, 3D, 4, and/or 5) may be performed in any order to perform a flow diagram, a method, or an alternate method.

At 402, the method 400 includes detecting an event associated with a first application on the first mobile device. For example, the application transfer controller 114 determines that a video call application (e.g., the first application) is currently running on the mobile device 102. Alternatively, the application transfer controller 114 determines that the video call application is scheduled to occur on the mobile device 102 (e.g., in 5 to 10 minutes, within the next hour, etc.).

At 404, the method 400 includes transmitting an interface of a second application installed on the first mobile device to a second mobile device based on the event associated with the first application and a request to use the second application on the first mobile device. For example, the application transfer controller 114 sends a request to the mobile device 104 to accept an interface of the second application (e.g., the application transfer interface 128). Based on an approval of the request, the application transfer controller 114 transmits an interface of the second application to the mobile device 104 (e.g., transmits instructions to generate an interface of the second application on the mobile device 104), enabling a user of the mobile device 104 to interact and/or control one or more aspects of the second application on the mobile device 104 while the second application executes on the mobile device 102 (e.g., concurrently with the first application executing on the mobile device 102).

At 406, the method 400 includes receiving, from the second mobile device, monitoring information associated with use of the second application on the second mobile device. For example, the application transfer controller 114 receives monitoring information that includes an indication that use of the second application is initiated on the mobile device 104 at a first time, an indication that that the second application is still being used on the mobile device 104 at a second time after the first time, and/or an indication that that use of the second application is ended on the mobile device 104 at a third time after the second time.

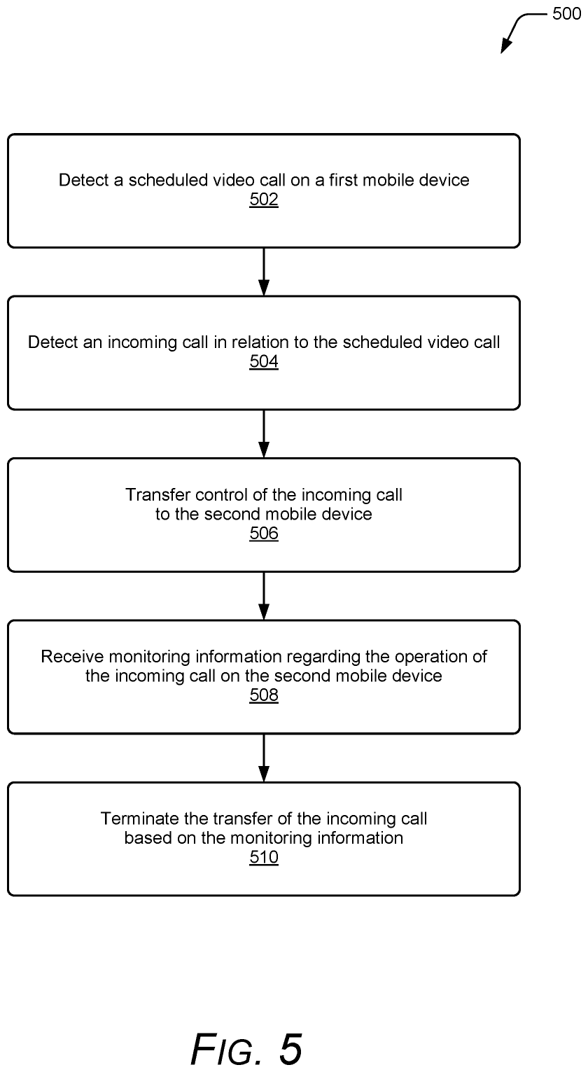

FIG. 5 illustrates example method(s) 500 for event-based application interface transmission across mobile devices. The order in which the method is described is not intended to be construed as a limitation, and any number or combination of the flow diagram and/or method operations described herein (e.g., of FIGS. 3A, 3B, 3C, 3D, 4, and/or 5) may be performed in any order to perform a flow diagram, a method, or an alternate method.

At 502, the method 500 includes detecting a scheduled video call on a first mobile device. For example, the application transfer controller 114 determines that a video call is scheduled to occur on the mobile device 102 within the next five minutes.

At 504, the method 500 includes detecting an incoming call in relation to the scheduled video call. For example, the application transfer controller 114 determines that an incoming call is from a person familiar to the user of the mobile device 102 (e.g., a family member, a friend, a coworker, a neighbor, a person listed on the user's contacts). Accordingly, the application transfer controller 114 displays a notification indicating that the incoming call potentially interferes with the scheduled video call. In example implementations, the video call is scheduled to occur using a wireless radio of the mobile device 102 (e.g., voice over Internet Protocol (VOIP) video call), and the incoming call is received over a cellular radio of the mobile device 102.

At 506, the method 500 includes transferring control of the incoming call with the second mobile device. For example, the application transfer controller 114 receives user input at the mobile device 102 (e.g., voice input, touchscreen input, device physical button input, etc.) indicating to transfer control of the incoming call to a second mobile device (e.g., the mobile device 104). In example implementations, the application transfer controller 114 shares control of the incoming call with the mobile device 104 concurrently with the video call on the mobile device 102. In one or more examples, the mobile device 102 processes the video call over the wireless radio of the mobile device 102 (e.g., VOIP connection) concurrently with processing the incoming call over the cellular radio of the mobile device 102. For example, the application transfer controller 114 maintains the video call over the wireless radio and transfers control of the incoming call to the mobile device 104 while continuing to handle the incoming call over the cellular radio of the mobile device 102. For instance, the application transfer controller 114 enables the mobile device 102 as a relay for the incoming call between a base station and the mobile device 104 while maintaining the video call.

At 508, the method 500 includes receiving monitoring information regarding the operation of the incoming call on the second mobile device. For example, the application transfer controller 114 receives monitoring information indicating the transferred phone call is answered on the mobile device 104, that the transferred phone call is ongoing on the mobile device 104, that the transferred phone call is ended on the mobile device 104.

At 510, the method 500 includes terminating the transfer of the incoming call based on the monitoring information. For example, the application transfer controller 114 detects, based on the monitoring information, that the mobile device 104 ends the transferred call. In response, the application transfer controller 114 terminates the sharing of the call to the second mobile device. For instance, the application transfer controller 114 instructs the mobile device 102 (e.g., the operating system 116 of the mobile device 102) to terminate execution of the incoming call (e.g., the second application 132) on the mobile device 102. As a result, sharing of the incoming call with the mobile device 104 is terminated.

FIG. 6 illustrates various components of an example device 600, which can implement aspects of the techniques and features for event-based application interface transmission across mobile devices, as described herein. The example device 600 may be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or the mobile device 104 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable mobile devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage mobile device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In one or more examples, the device 600 includes an application transfer controller 618 that implements various aspects of the described features and techniques described herein. The application transfer controller 618 is implemented with hardware components and/or in software as one of the device applications 614, such as when the example device 600 is implemented as the mobile device 102 and/or the mobile device 104 described with reference to FIGS. 1-5. An example of the application transfer controller 618 is the application transfer controller 114 implemented by the mobile device 102 and/or the mobile device 104, such as a software application and/or as hardware components in the mobile device 102 and/or in the mobile device 104. In implementations, the application transfer controller 618 includes independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for event-based application interface transmission across mobile devices have been described in language specific to features and/or methods, the appended claims are not necessarily limited to the specific features or methods described. Rather, the specific features and methods are disclosed as example implementations for event-based application interface transmission across mobile devices, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a first mobile device, including: at least one memory, and at least one processor coupled with the at least one memory configured to cause the first mobile device to: detect an event associated with a first application on the first mobile device, transmit an interface of a second application installed on the first mobile device to a second mobile device based on the event associated with the first application and a request to use the second application on the first mobile device, and receive, from the second mobile device, monitoring information associated with use of the second application on the second mobile device.

In some aspects, the techniques described herein relate to a first mobile device, wherein the first application and the second application execute on the first mobile device.

In some aspects, the techniques described herein relate to a first mobile device, wherein: the first application utilizes a first wireless technology, and the second application utilizes a second wireless technology different from the first wireless technology.

In some aspects, the techniques described herein relate to a first mobile device, wherein: the first application is a video call application that utilizes at least one of a voice over internet protocol (VOIP) connection, a cellular connection, or a Wi-Fi connection, and the second application is an incoming call that utilizes at least one of the VOIP connection, the cellular connection, or the Wi-Fi connection.

In some aspects, the techniques described herein relate to a first mobile device, wherein the event includes an active use of the first application on the first mobile device.

In some aspects, the techniques described herein relate to a first mobile device, wherein the event includes a scheduled use of the first application on the first mobile device that conflicts with using the second application on the first mobile device.

In some aspects, the techniques described herein relate to a first mobile device, wherein the request to use the second application includes at least one of an incoming phone call, a notification on a display of the first mobile device, or a message received at the first mobile device.

In some aspects, the techniques described herein relate to a first mobile device, wherein the interface of the second application is transmitted in response to an approval of the request received at the first mobile device.

In some aspects, the techniques described herein relate to a first mobile device, wherein the at least one processor is configured to cause the first mobile device to terminate transmission of the interface of the second application to the second mobile device based on the monitoring information of the second application indicating that the second application is closed on the second mobile device or based on user input received at the first mobile device.

In some aspects, the techniques described herein relate to a first mobile device, wherein the interface of the second application transmitted to the second mobile device differs from an interface displayed on the first mobile device that is associated with the second application.

In some aspects, the techniques described herein relate to a method, including: detecting an event associated with a first application on a first mobile device, transmitting an interface of a second application installed on the first mobile device to a second mobile device based on the event associated with the first application and a request to use the second application on the first mobile device, and receiving, from the second mobile device, monitoring information associated with use of the second application on the second mobile device.

In some aspects, the techniques described herein relate to a method, wherein the first application and the second application execute on the first mobile device.

In some aspects, the techniques described herein relate to a method, wherein: the first application utilizes a first wireless technology, and the second application utilizes a second wireless technology different from the first wireless technology.

In some aspects, the techniques described herein relate to a method, wherein: the first application is a video call application that utilizes at least one of a voice over internet protocol (VOIP) connection, a cellular connection, or a Wi-Fi connection, and the second application is an incoming call that utilizes at least one of the VOIP connection, the cellular connection, or the Wi-Fi connection.

In some aspects, the techniques described herein relate to a method, wherein the event includes at least one of an active use of the first application on the first mobile device or a scheduled use of the first application on the first mobile device that conflicts with using the second application on the first mobile device.

In some aspects, the techniques described herein relate to a method, wherein the request to use the second application includes at least one of an incoming phone call, a notification on a display of the first mobile device, or a message received at the first mobile device.

In some aspects, the techniques described herein relate to a system, including: a communication interface to wirelessly link connected devices that include a first mobile device linked to a second mobile device, and an application streaming controller configured to share one or more applications of the first mobile device with one or more mobile devices that include the second mobile device, the application streaming controller implemented at least partially in computer hardware to: detect an event associated with a first application on the first mobile device, transmit an interface of a second application installed on the first mobile device to the second mobile device based on the event associated with the first application and a request to use the second application on the first mobile device, and receive, from the second mobile device, monitoring information associated with use of the second application on the second mobile device.

In some aspects, the techniques described herein relate to a system, wherein the first application and the second application execute on the first mobile device.

In some aspects, the techniques described herein relate to a system, wherein: the first application utilizes a first wireless technology, and the second application utilizes a second wireless technology different from the first wireless technology.

In some aspects, the techniques described herein relate to a system, wherein: the first application is a video call application that utilizes at least one of a voice over internet protocol (VOIP) connection, a cellular connection, or a Wi-Fi connection, and the second application is an incoming call that utilizes at least one of the VOIP connection, the cellular connection, or the Wi-Fi connection.

1. A first mobile device, comprising:
at least one memory; and
at least one processor coupled with the at least one memory configured to cause the first mobile device to:
detect an event associated with a first application on the first mobile device;
transmit an interface of a second application installed on the first mobile device to a second mobile device based on the event associated with the first application and a request to use the second application on the first mobile device; and
receive, from the second mobile device, monitoring information associated with use of the second application on the second mobile device.

2. The first mobile device of claim 1, wherein the first application and the second application execute on the first mobile device.

3. The first mobile device of claim 1, wherein:
the first application utilizes a first wireless technology; and
the second application utilizes a second wireless technology different from the first wireless technology.

4. The first mobile device of claim 1, wherein:
the first application is a video call application that utilizes at least one of a voice over internet protocol (VOIP) connection, a cellular connection, or a Wi-Fi connection; and
the second application is an incoming call that utilizes at least one of the VOIP connection, the cellular connection, or the Wi-Fi connection.

5. The first mobile device of claim 1, wherein the event includes an active use of the first application on the first mobile device.

6. The first mobile device of claim 1, wherein the event includes a scheduled use of the first application on the first mobile device that conflicts with using the second application on the first mobile device.

7. The first mobile device of claim 1, wherein the request to use the second application includes at least one of an incoming phone call, a notification on a display of the first mobile device, or a message received at the first mobile device.

8. The first mobile device of claim 1, wherein the interface of the second application is transmitted in response to an approval of the request received at the first mobile device.

9. The first mobile device of claim 1, wherein the at least one processor is configured to cause the first mobile device to terminate transmission of the interface of the second application to the second mobile device based on the monitoring information of the second application indicating that the second application is closed on the second mobile device or based on user input received at the first mobile device.

10. The first mobile device of claim 1, wherein the interface of the second application transmitted to the second mobile device differs from an interface displayed on the first mobile device that is associated with the second application.

11. A method, comprising:
detecting an event associated with a first application on a first mobile device;
transmitting an interface of a second application installed on the first mobile device to a second mobile device based on the event associated with the first application and a request to use the second application on the first mobile device; and
receiving, from the second mobile device, monitoring information associated with use of the second application on the second mobile device.

12. The method of claim 11, wherein the first application and the second application execute on the first mobile device.

13. The method of claim 11, wherein:
the first application utilizes a first wireless technology; and
the second application utilizes a second wireless technology different from the first wireless technology.

14. The method of claim 11, wherein:
the first application is a video call application that utilizes at least one of a voice over internet protocol (VOIP) connection, a cellular connection, or a Wi-Fi connection; and
the second application is an incoming call that utilizes at least one of the VOIP connection, the cellular connection, or the Wi-Fi connection.

15. The method of claim 11, wherein the event includes at least one of an active use of the first application on the first mobile device or a scheduled use of the first application on the first mobile device that conflicts with using the second application on the first mobile device.

16. The method of claim 11, wherein the request to use the second application includes at least one of an incoming phone call, a notification on a display of the first mobile device, or a message received at the first mobile device.

17. A system, comprising:
a communication interface to wirelessly link connected devices that include a first mobile device linked to a second mobile device; and
an application streaming controller configured to share one or more applications of the first mobile device with one or more mobile devices that include the second mobile device, the application streaming controller implemented at least partially in computer hardware to:
detect an event associated with a first application on the first mobile device;
transmit an interface of a second application installed on the first mobile device to the second mobile device based on the event associated with the first application and a request to use the second application on the first mobile device; and
receive, from the second mobile device, monitoring information associated with use of the second application on the second mobile device.

18. The system of claim 17, wherein the first application and the second application execute on the first mobile device.

19. The system of claim 17, wherein:
the first application utilizes a first wireless technology; and
the second application utilizes a second wireless technology different from the first wireless technology.

20. The system of claim 17, wherein:
the first application is a video call application that utilizes at least one of a voice over internet protocol (VOIP) connection, a cellular connection, or a Wi-Fi connection; and
the second application is an incoming call that utilizes at least one of the VOIP connection, the cellular connection, or the Wi-Fi connection.
